(19) United States
(12) Patent Application Publication
(10) Pub. No.: US 2004/0187863 A1
(43) Pub. Date: Sep. 30, 2004

(54) Biomilling and grain fractionation

(75) Inventor: Leon Langhauser, Decatur, IL (US)

Correspondence Address: PHILIP L BATEMAN, P O BOX 1105, DECATUR, IL, 62525

(73) Assignee: Langhauser Associates Inc.

(21) Appl. No.: 10/400,020

(22) Filed: Mar. 25, 2003

(51) Int. Cl. A23N 1/00

(52) U.S. Cl. 127/24; 127/27; 127/38; 127/40; 210/634

(57) ABSTRACT

The present invention includes a method for producing ethanol from grain. The method includes: Steeping the corn kernels in tepid water, free of sulfurous acid, in a steeping reactor for 16-20 hours, soaking with recycled enzyme; Milling the soaked corn kernels to separate the germ and soft starch to form a starch-gluten-fiber particle; Extracting the germ in a cyclone reactor; separating the starch to produce a sugar/protein fermentative media; washing the fiber to produce extractables and cellulose products; liquefying in a high speed homogenizer to separate the gluten and fiber to form a starch gel; Fermenting the starch gel to form ethanol and gluten; centrifuging to produce a protein concentrate and yeast cream; and Distilling the ethanol to make beverage, industrial or fuel grade ethanol

### BACKGROUND

The present invention relates to a method and to a system for fractionating and milling corn and other cereal grains.

Grain milling, such as corn milling, has been performed in the United States since about 1842. Two types of grain milling have been developed, wet milling and dry milling. As suggested by the name, wet milling employs water during grinding and in dry milling, grain such as corn, is ground without water.

Over the years, wet grain milling processes have gone from batch processes to continuous processes. One prior art wet milling process is illustrated at 1 in FIG. 1A. The wet milling processes have improved in efficiency by re-using aqueous process streams, and by performing counter-current operations, in order to recover corn constituents. Specifically, in wet milling, a soluble protein component of grain is steeped, as shown at 2, in FIG. 1, extracted, and washed before grinding, as shown at 3. Components of grain, such as germ fiber and gluten are extracted, as shown at 4 and 5 before starch is finally washed, as shown at 6 in FIG. 1.

Prior art wet milling of corn produces a high purity cornstarch slurry suitable for high quality corn starch and for syrup production that yields dextrin, dextrose, and fructose. Starch has also been used for fermentation products such as citric acid, lactic acid and ethyl alcohol. Typically, soluble proteins washed out of corn are added back to a fermentation broth.

Fresh potable water is used to wash the wet milled starch. The water is re-used in a counter-current operation to the process flow to wash the gluten, fiber, and germ before finally being used for steeping the soluble protein from the corn before grinding. Yield of products is reduced due to fermentation and retention with the wastewater which must be treated before disposal.

Dry milling of corn has been used to produce similar products to wet milling, such as corn germ and corn grits but without the efficiencies of wet milling that reclaims a high purity starch as a final product. One prior art dry milling process is shown at 100 in FIG. 1B.

Dry milling has been used to produce ethyl alcohol without removal of any of the constituents of a corn kernel. Carbon dioxide is produced during fermentation and is collected and liquefied or frozen for sale as a co-product, as shown at 101. The starch is liquefied and fermented to ethyl alcohol in the presence of the other constituents of the corn but not with the efficiencies achieved when washed starch is used. The yield of ethyl alcohol is improved when using the dry milling process because starch left on the constituent corn residues are collected and converted to ethyl alcohol.

Prior art ethyl alcohol plants include zero discharge plants. Corn constituents not converted to ethyl alcohol or carbon dioxide are concentrated into a distiller's grain that is used as animal feed. Waste streams are recycled back into the system for reuse.

### SUMMARY

In its method aspect, the present invention includes a method for continuously producing products typically associated with wet milling and ethanol production, with improved yields. The method increases conversion, reduces fermentation losses and produces no waste streams. The method includes providing corn kernels comprising a germ, protein, gluten, starch, and fiber. The method also includes soaking the corn kernels in tepid water, free of sulfurous acid, containing recycled enzyme from downstream processes, in a steeping reactor for 16-20 hours to increase moisture of the corn kernels; milling the soaked corn kernels to separate the germ and to form a starch-gluten-fiber particle; extracting the germ in a cyclone reactor; screening starch for fermentation media; washing the fiber for extraction of cellulose products; liquefying the starch-gluten-fiber particle at an increased dry substance; washing the fiber for extraction of cellulose solubles and products; Saccharifying and fermenting the starch gel to form ethanol; centrifuging the media to produce protein concentrate and yeast cream; and distilling the ethanol to produce one or more of beverage, industrial and fuel grade ethanol.

In its system aspect, the present invention includes a system for extracting one or more of starch, germ, fiber, protein, from grain, comprising:

A steeping bioreactor effective for loosening a germ component from grain, and freeing a soft starch component of the endosperm;

A mill effective for separating the germ from the grain without fracturing the germ; and

A high speed homogenizing, centrifugal mill for separating starch from fiber and for breaking the gluten-starch matrix of the endosperm for forming a starch gel;

A continuous fermentation system designed to flush contaminants; optimize yeast activity and continuously draw off carbon dioxide with capability of catalyst and yeast recycle.

In another method embodiment, the present invention includes a method for producing ethanol from grain. The method includes providing grain particles comprising two or more of a germ, soft endosperm starch, hard endosperm starch-gluten matrix, and fiber; soaking the grain particles in tepid water, free of sulfurous acid, in a steeping reactor for 16-20 hours to soak with recycled enzymes; milling the soaked grain particles to separate the germ and soft starch, hard starch-protein fiber; extracting the germ in a cyclone reactor; separating the soft starch to produce a quality sugar-protein fermentation media; homogenizing the hard starch-protein-fiber to liquefy the starch; washing the fiber to produce extractables and cellulose products; saccharifying and fermenting the gel to ethanol; centrifuging the fermented broth to produce protein concentrate and yeast cream; and distilling the ethanol to make one or more of beverage, industrial or fuel grade ethanol.

The present invention also includes an optional pre-cleaning mechanism for separating grain particles. Damaged or high moisture grain or elevator dust can be processed in the method of the present invention.

The mechanism includes a mechanism for separating the germ from the grain particle without fracturing the germ; a mechanism for separating quality starch from hard starch; a mechanism for liquefying the starch from the hard starch and the fiber; a mechanism for forming ethanol from the liquefied starch; a mechanism for distilling ethanol; and a mechanism for isolating high protein, non-ruminant feed.

### DESCRIPTION OF DRAWINGS

FIG. 1A is a prior art schematic view of one wet milling process embodiment.

FIG. 1B is a prior art schematic view of one dry milling alcohol process embodiment.

FIG. 1C is a schematic view of one embodiment of the milling process of the present invention.

FIG. 1D is a schematic comparative view of a prior art liquefaction system and the liquefaction system of the present invention.

FIG. 2A is a schematic view of a steeping reactor used in the process of the present invention, including germ extraction.

FIG. 2B is a schematic view of the liquefaction systems separating a high quality, sugar fermentation media stream and fiber washing and fiber extraction process of the present invention.

FIG. 3A is a schematic/axial view of a portion of a rotor/stator device.

FIG. 3B is a perspective view of a portion of the rotor/stator device used in the process of the present invention.

FIG. 3C is a cross-sectional view of a portion of the rotor/stator device used in the process of the present invention.

FIG. 4 is a schematic view of one fermentation batch process converted to a continuous process of the present invention.

### DETAILED DESCRIPTION

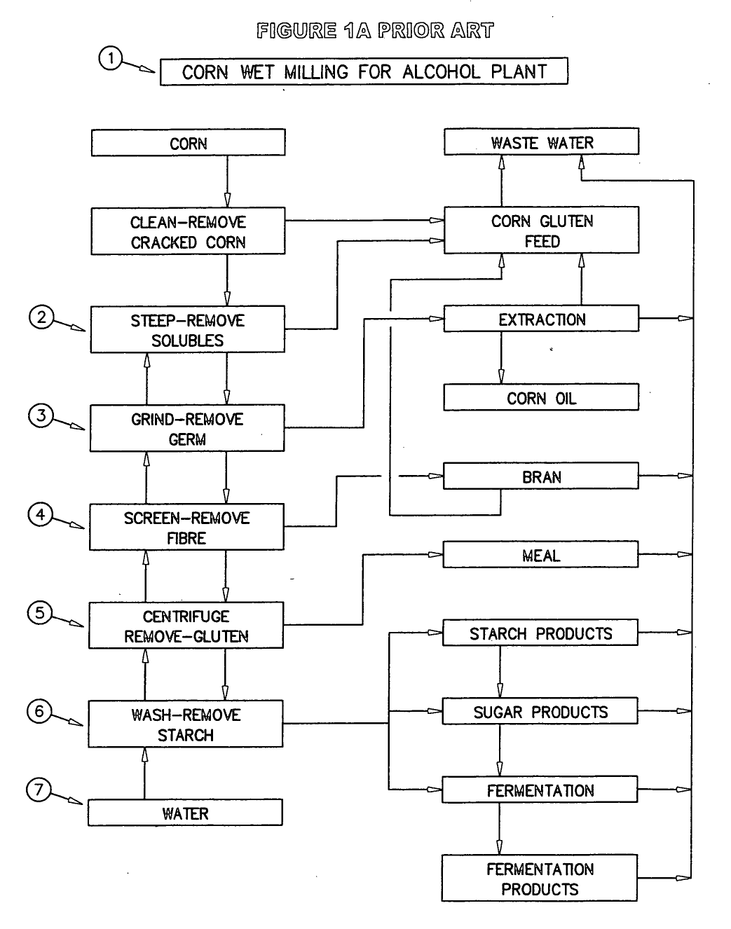

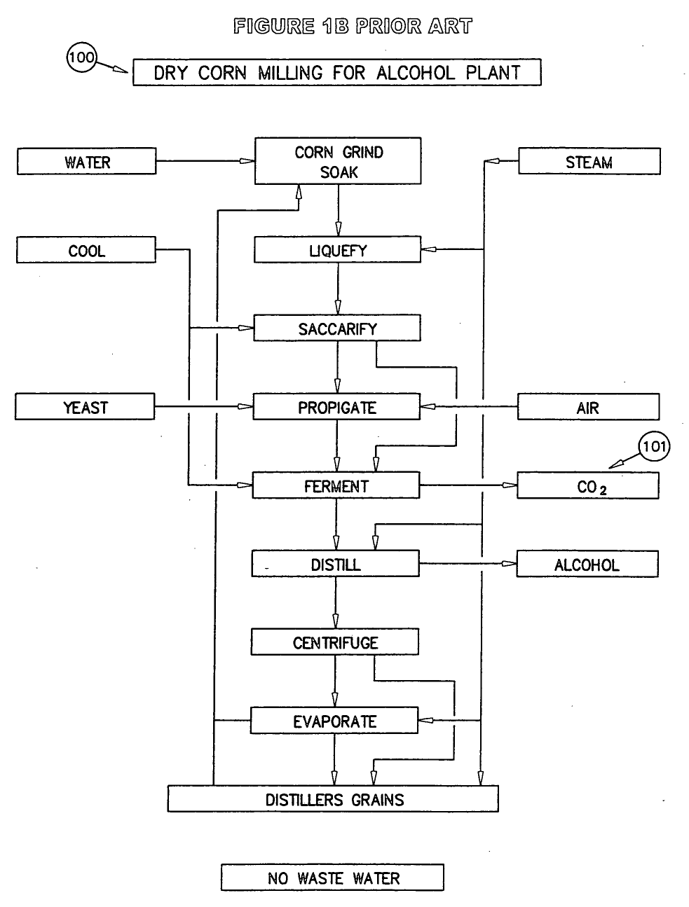

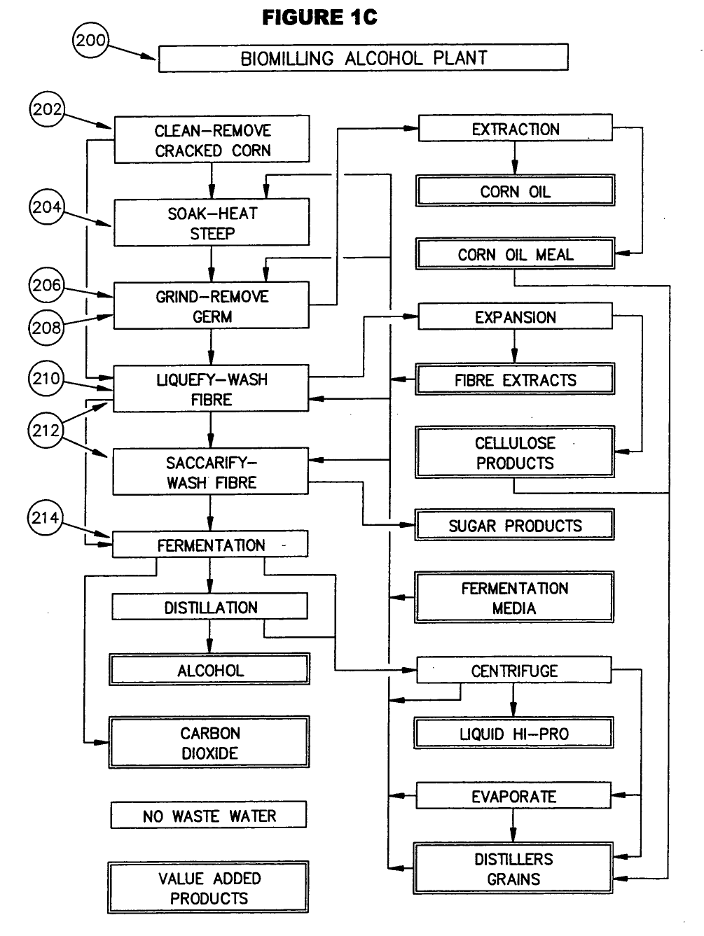

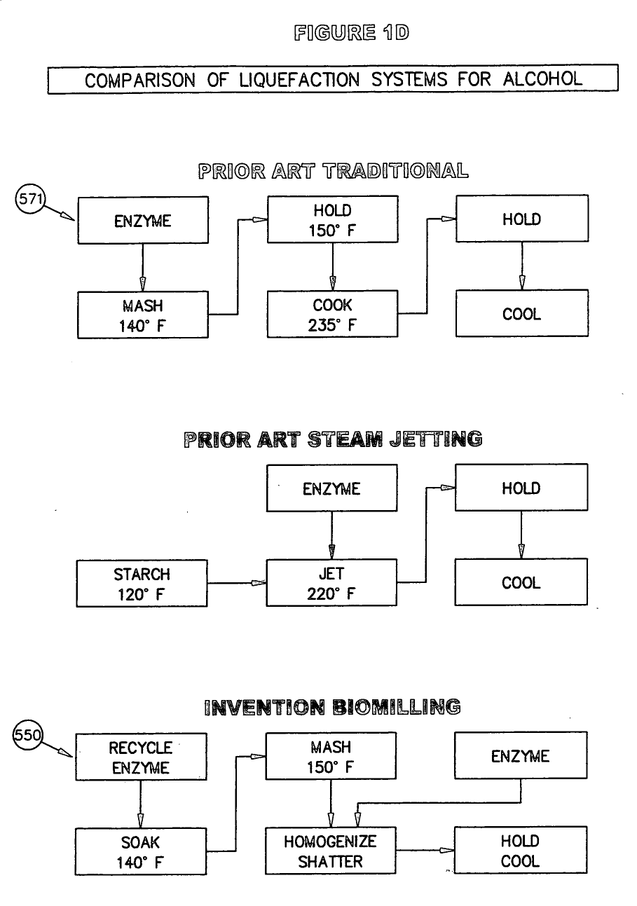

The grain fractionation and grain milling process of the present invention, one embodiment of which is shown schematically at 200 in FIG. 1C includes providing a grain that has a starch component, a germ component, and other constituents such as fiber, gluten, starch and protein, shown for corn at 202, and pre-treating the grain; soaking the grain in a plug flow, counter-current reactor 204; grinding the soaked grain to separate the germ from the rest of the grain 206; separate the grain by flotation 208; removing high quality starch for separate liquefaction 210; liquefying remaining components; separating high quality fiber 212; and fermenting the remaining saccharified sugar starch to make ethanol 214. Dry screenings and other starch containing materials and cereal grains are optionally added at a final liquefied step. The grain fractionation and grain milling process of the present invention converts grains such as corn to valuable products, without producing waste.

Grains usable in the method of the present invention include any grain with a starch component including hard starch and soft starch, and, optionally, a germ component. Specific grains include, but are not limited to corn, maize, rice, oats, sago, barley, canola, cassava, buckwheat, Jerusalem artichokes, mustard seed, flax, fava beans, lentils, peas, rye, safflower, soy, sunflower seeds, tricale, and wheat. Corn usable in the present invention includes commercial corn grade, such as United States Grade No. 2 or any other grade including damaged corn or elevator dust. Starch includes any starch or sugar, dry or any moisture content, containing fermentable materials.

The grain pre-treatment includes separating the grain seeds or kernels from other plant structures. In particular, kernels of corn are shelled from a corncob. Separation equipment known to those skilled in the art is usable in separating the corn from cob, stover and stocks. The separated corn particles are cleaned, weighed in bulk, for addition to a soaking reactor for subsequent reaction and preparation to remove the germ.

The description that follows refers to a use of corn. It is understood, however, that other types of grain particles and mixtures of grain particles are suitable for use in the method of the present invention.

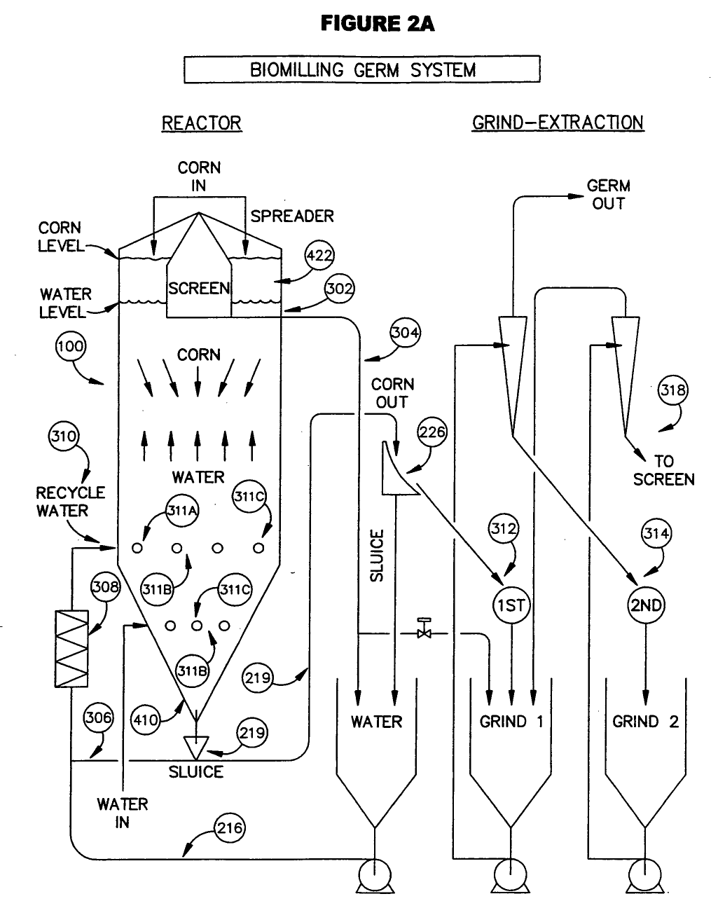

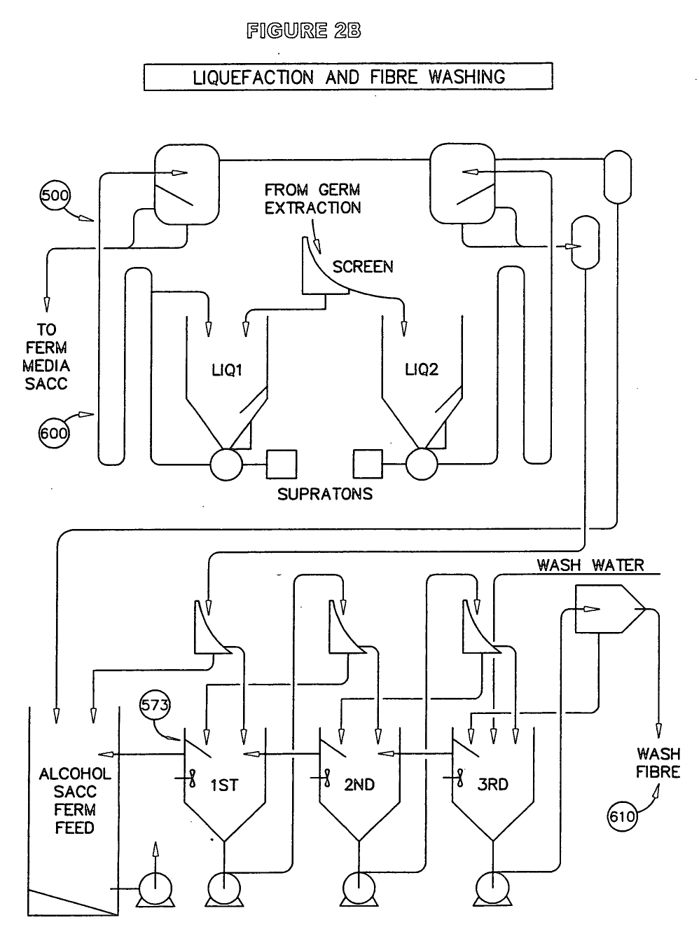

The cleaned, corn kernels are then added to a reactor, one embodiment of which is shown at 300 in FIG. 2A, containing water in a manner that forms a plug for plug flow down the reactor. Tepid water, in one embodiment, within a range of 125 degrees Fahrenheit to 160 degrees Fahrenheit is percolated through the corn from the bottom to the top of the plug flow. Corn is continuously added to the reactor. In particular, the corn is spread on the top of the reactor so that all light corn particles are trapped in the corn before the corn is introduced to soaking water, as shown at 302. The plug flow of corn passes down the reactor in which water used for heating, soaking and enzyme reaction flows to the top of the reactor where it is discharged at 304.

Water enters the reactor on a slope of the discharge of the side of the reactor to provide sluice at 306, to add recycled enzymes and other chemicals to initiate the reaction and to control conditions for further processing.

Water is recycled through a heat exchanger control 308 and re-cycled to the reactor above the process recycle water entry point 310. The reactor provides for continuous heating, soaking and enzyme reaction. The flow is counter-current in that a plug flow of corn kernels passes down the reactor while water flows upward.

The water in the reactor has, in one embodiment, a pH of 4.5 to 6.5. The reactor provides for continuous soaking of corn. The flow is counter-current in that a plug flow of corn kernels passes down the reactor 200 while water used for reaction flows to the top of the reactor at 220, where it is discharged.

Distributors and collector configuration are configured to obtain plug flow of both the grain and the reactants with continuous biomilling operation.

In one embodiment, illustrated in FIG. 2A the reactor 300 terminates in a central cone 412. The cone is sloped at greater than 67 degrees and has smooth surface of No. 4 polish stainless steel or better which is free of rough spots or welds. The water makeup is distributed around the cone and contributes to the free flow of the grain down the slope of the center of the reactor. Sugars in the make-up recycle water are returned to the process flow along with the active enzyme.

Recycle water is added above the cone at 310 and distributed around the tank arranged to prevent channeling of the plug flow of the corn. All of the water not recycled to sluice the corn down to the bottom of the cone is drawn off the reactor at the top center collector.

The same reactor is usable to steep corn for a wet milling processor or to treat grain size particles with solvent to soften the grain size particles and extract the soluble portions.

The interior surface of the reactor is smooth, free from rough spots or welds. The reactor 300 includes an outlet 304 that is positioned below a water makeup inlet 416 to the steeping reactor 400. The makeup water is distributed in the reactor by a water manifold with a plurality of inlets 311A, 311B, 311C, 311D, 311E, 311F, 311G, 311H that are used for distributing water to the reactor, addition of enzyme, washing the corn and sluicing the cone discharge. The manifold 311A-H is arranged to prevent channeling of the plug flow.

The water is recycle water and is added at an outside wall distributed above the discharge cone. The water is collected at the center of the reactor at the top of the reactor just below the incoming corn. This flow is designed to keep grain moving down in a plug flow fashion which keeps corn at the outside moving down at the same rate as in the center. Corn naturally moves down the center of the reactor at a faster rate than in prior art steeping or soaking reactors without prior art distributor designs.

Water used in the steeping process is drawn off at the top of the reactor at 304. As used herein, the term “steep” refers to water exposed to the plug flow, in the reactor 300. The bottom of the reactor is designed with sufficient slope that the corn is continuously removed as a plug flow. Excess water volume is controlled, in one embodiment, with an orifice at the bottom center of the reactor.

A center collector at the top of the reactor distributes the grain level from the center to the outside of the reactor; collects the water for return or recycle; and is continuously cleaned by the grain moving down the collector. This design traps materials that would normally choke the collector screen and broken kernels and floaters in the corn mass as it moves down the reactor.

The processing performed in the reactor is soaking of the corn kernels. The cleaned corn kernels are added to the top of the reactor and are soaked for 16 to 20 hours in tepid water at a pH of 4.5 to 6.5. The corn kernels are soaked to facilitate germ removal and to reduce requirements for chemical usage downstream. In particular, soaking “toughens” the germ and renders it easier to separate without fractionation. Soaking removes soluble solids from the corn kernels. As water permeates through the grain membrane, soaking softens the corn kernels and facilitates breaking or rupturing the gluten starch matrix in subsequent processing.

The corn kernels are distributed evenly at the top of the reactor above the water level 422 and, over a period of 16 to 20 hours, move down the reactor in a plug flow fashion. The corn kernels are spread uniformly over the top of the water to prevent over-concentration within an area thereby destroying flow uniformity in the plug flow. In one embodiment, a corn kernel spreader aids in creating a uniform distribution of grain. Floaters, dust, and cracked grain are trapped in the grain mass moving down. The grain seals the top of the tank. Moisture is sealed from the headspace which negates the necessity of a vent to the environment. Moisture and media do not collect above the grain plug to react with bacteria, yeast, molds or chemical reaction.

Heated water is added to the reactor at 311A-H at a rate of 2-3 GPM/ft(2) in order to make up for water discharged out of the reactor at 304. The heated water also controls viscosity of the mass, and improves soluble permeation of the corn particles. The heat activates the maltase enzymes, the recycled enzymes and alpha glucosidases in the grain and facilitates the reaction of the recycled enzymes to convert the soluble starches to sugars. The temperature is high enough to retard yeast fermentation and acetic and lactic acid bacterial reactions.

Once the corn kernel plug reaches the bottom of the reactor, the corn kernel particles are washed with fresh water and are discharged from the reactor at 214. In one embodiment, a rotary valve is optionally used in lieu of a regulating orifice to adjust the flow of the corn kernel plug and water out of the reactor 300. Processing or soaking water is separated from the corn kernels by use of a screen 226 that retains the soaked corn kernels. Steeping water passing through the screen 226 is recycled back into the reactor 300 through makeup line 216.

The soaked corn kernel particles are then passed through a series of pin mills 312 and 314. One type of mill used in the method of the present invention is a Stedman Cage Mill, manufactured by Stedman of Aurora, Ind. While the Stedman Cage Mill is described, it is believed that other mills are usable for the germ separation of the present invention. The mill is fitted with cage pins and breaker plates. The mill does not include screens or hammers. The pin mills separate the germ from the remainder of the corn kernel without rupturing the germ.

The soaking weakens the structure binding the germ to the remainder of a corn particle so that less energy is required to separate the germ than is required for germ separation of corn kernels that are not pre-soaked for 16 to 20 hours. The structure weakening occurs even though the water is not treated with sulfurous or lactic acid. The germ is separated from the remainder of the corn articles. The milled corn mash is concentrated to 16-17% dry solids.

The germ fraction floats in a solution of liquid at 16 to 17 percent dry substance (DS). The remaining portions settle in the solution. The solution is added to a cyclone type reactor for separation. Stages of grind and cyclones are optionally added to improve yield. The germ is then dewatered and washed to free the germ from residual starch and protein. The germ is usable for a process such as production of corn oil and corn oil meal.

Other benefits from soaking include a reduction of energy in corn kernel grinding required. Natural grain enzyme and process recycled enzymes initiate and improve the reaction in the initial soaking reactor.

Soaking permits separation of the starch in the corn from protein without breaking the protein matrix. Because most of the starch is used without breaking the protein matrix of the corn, further grinding is not required. Because soaking occurs without sulfurous acid or lactic acid production, at a pH near neutral, cost of materials of construction of reactor and other process components are reduced because corrosion is minimized. Soaking in the plug flow of the present invention increases moisture of corn particles at a faster and more uniform rate than in previous processes.

The remainder of the corn particles are then milled in one or more degerminating mills. The degerminating mills remove any residual germ from the corn particles. The degermination mills also reduce the size of the remainder of corn particles for fiber removal. The germ is separated from the remainder of the corn particles in the degermination mills. Once all the germ is removed, other materials, including other grains, are, in some embodiments, added to the remainder of the corn particles. Other materials include grain cleanings, dry grain or other cereal grains. A third will not be necessary as the homogenizer will provide sufficient size reduction of all materials.

After the corn is treated in the degerminating mills, the remainder of corn particles includes a slurry of starch, protein, gluten, fiber and fragments of grain particles, such as a fraction of a kernel. The slurry is subjected to screening or pressing using conventional methods, shown at 318, that separate starch and gluten from other coarser materials in the slurry, such as fiber. Thus, fiber is retained on the screens while gluten and starch pass through the screens.

The coarser materials are further screened. In one embodiment, the fiber is not ground and is separated and washed as it passes through a series of screens. The fiber is then dewatered and treated for further separation into value added products such as pectin, cellulose, lignin, mannose, xylose, arabinose, galactose, and galacturonic acid.

After the starch-gluten slurry is screened to remove any residual fiber, the starch-gluten slurry is subjected to liquefaction of the starch, shown schematically at 500. In this embodiment, the washed starch is converted to sugars as a first step in syrup production to produce quality fermentation media.

In one embodiment, all of the rejection streams from the separation and washing of the germ, fiber, gluten, and starch are collected for concentration, forming a concentrated stream. Any stream not separated is added to this stream. The concentrated stream is concentrated in a decanter centrifuge, shown at 320 in FIG. 2A, for liquefaction prior to saccharification and fermentation. The stream is concentrated to provide sufficient sugars to produce 17 to 20% alcohols in the feed for ethanol distillation.

The streams collected for liquefaction are liquefied in a specially designed rotary homogenizer 513 that provides maximum shear and a reduced viscosity. Two commercially produced high-frequency, rotor-stator dispersion devices are the Supraton™ devices manufactured by BWS Technologie, GmbH and marketed by Centrisys. Inc, Kenosha, Wis., and the DispaxTM devices manufactured and marketed by Ika-Works, Inc. of Cincinnati, Ohio. The Supraton homogenizer is a rotor-stator machine having intermeshing radial surfaces.

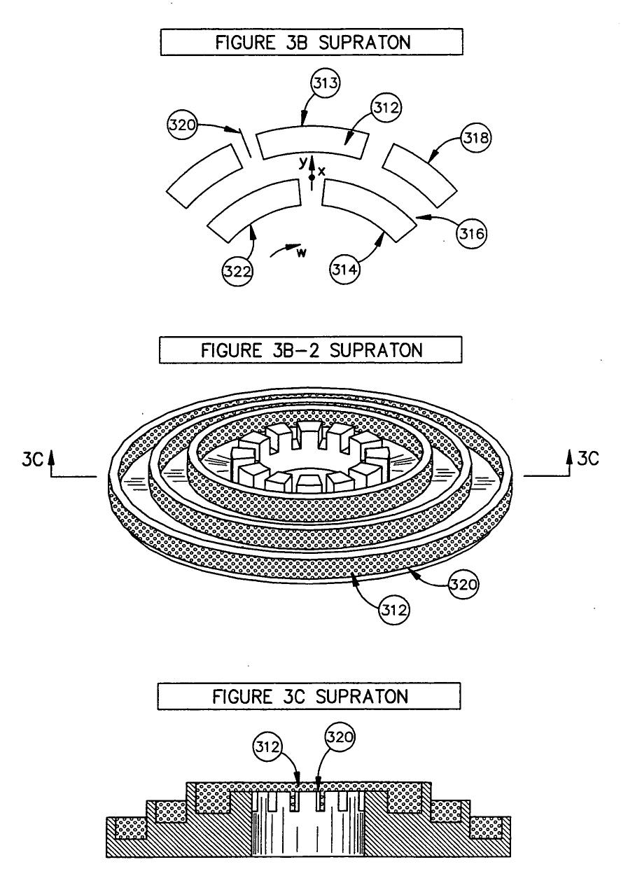

Referring to FIGS. 3A and 3B, a slurry is fed into the high-frequency, rotor-stator device and forced into a chamber 313. Inside the chamber is a series of coaxial meshing rings. The rings are configured with teeth, slots or bore holes. The slurry is fed in conjunction with a steam feed in order to control the steam heat as it comes into contact with the slurry. The slurry is concentrated at 28 to 42 percent DS. An enzyme catalyst or chemical is added to the slurry. Because of the mixing that occurs, less chemical pre-treatment is required for enzyme activation. Reduced enzyme concentration is required because of an ultrafine distribution of enzyme or chemical. The liquefaction occurs at a reduced temperature that increases the half life of the enzyme. The temperature of liquefaction is between 70 and 115 degrees Centigrade (158 and 239 degrees Fahrenheit). Due to the reduced viscosity at these temperatures, less discharge pressure is required to move the liquefied mass.

The rings configured with teeth are generally known as tooth and chamber tools and those configured with bore holes are generally known as nozzle tools. Generally, tooth and chamber tools are attached to both the rotor and the stator when tooth and chamber tools are used. When nozzle tools are used, generally, a tooth and chamber type tool is affixed to the rotor and a nozzle tool is affixed to the stator.

The rings are concentric, radiating out from the center. The rings 312 on the stator are fixed and the rings 314 on the rotor are rotated by a shaft coupled to a motor.

The structure identified as 316 is representative of a tooth on a tooth and chamber tool attached to the rotor. The structure identified as 318 is representative of both a tooth on a tooth and chamber tool attached to the stator and the body of a nozzle tool spaced between bore holes. Accordingly, the space identified as 322 represents the gap between the teeth on a tooth and chamber tool attached to the rotor. The space identified as 320 represents both the gap between teeth on a tooth and chamber tool attached to the stator and the gap formed by a bore hole in a nozzle tool attached to the stator. The rings 314 on the rotor and the rings 312 on the stator are closely spaced at close tolerances. The space between the rotor and stator is typically about 1 mm.

Regarding a tooth and chamber tool, adjacent pairs of teeth are separated by gaps 320 and 322. The tooth and gap size determine the coarseness of the machine, i.e., a coarse tool has fewer teeth with larger gaps between adjacent teeth when compared with a medium or fine tool. Both the SupratonTM and DispaxTM allow the use of coarse, medium, and fine toothed rings in the same device, or the devices have all coarse, all medium, or all fine toothed rings in the chamber so that the machines are optionally used in series, if desired. The use of multiple devices in series is one embodiment to the use of a single device for processing the starch slurry.

As the starch slurry is pumped under pressure into the chamber 313 by the mixer-grinder-pump, the slurry encounters each concentric layer of the tools in place in the chamber as the slurry is forced laterally. This lateral force is created by the pressure on the slurry as it is pumped into the chamber by the mixer-grinder-pump and by the centrifugal force created by the spinning rotor. The slurry passes through the gaps between the teeth as the rotor spins past the gaps in the stator. Flow is most pronounced when the gaps 322 between the rotor teeth align with the gaps 320 in the stator. The result is a pulsing flow with a rapid succession of compressive and decompressive forces. The starch in the slurry is subjected to these repeated forces, as the centrifugal force accelerates it through the gaps toward the outer edge of the chamber. As the slurry moves towards the outer edge of chamber 313, the centrifugal forces increases, thus intensifying the forces generated in gaps 320 and 322. The repeated compressive and decompressive forces create microcavities in the slurry with intensive energy zones. The starch particles are ripped apart by these forces, forming a gel. Additionally, the resulting particles exhibit extensive internal decrystallization due to the forces generated in the microcavities.

Grinding typically cuts, slices, and dices starch material perpendicular to the starch particle, producing a more spherical type of particle. Shear forces in combination with microcavitation, on the other hand, tend to shatter the starch particles, that is, they rip the starch particles apart from the inside-out explosively forming irregularly shaped particles. Examination of these particles show them to have been “cut” both perpendicular to the particle axis and longitudinally along the particle axis. The effect on the starch particles is to shatter their structure, disrupting the starch/gluten/fiber matrix molecule bonding without the compressive effects of grinding. Solids loadings not exceeding 40% are employed in some embodiments to minimize grinding of the starch particles and thus the compressive effects of the grinding.

While the precise mechanisms occurring within the chamber of the high-frequency, rotor-stator device are not totally understood, several factors are thought to aid in the explaining the effects on the starch particles. The swelling effect of liquids, particularly water and dilute alkaline solutions, is thought to aid in creation of longitudinal shearing effects in the starch particles. The repeated compressive and decompressive events in and between the gaps are thought to create internal pressures tending to explode the starch particles and thus the fibrous structure thereof. It is also hypothesized that a harmonic resonance effect is created during operation of the rotor-stator device in the sonic range. Thus, a harmonic frequency of a particular starch particle diameter when reached during processing would cause the effected fibers to resonate and tend to aid in the destruction of the fibrous structure of the starch.

As previously stated, high-frequency, rotor-stator dispersion devices have differently configured rings or “tools” within the chamber. These tools, for example, vary in the gap size between the teeth on the rings or in bore hole size in the case of a nozzle tool. With a larger gap size, the resulting material is more coarse than with a smaller gap size. As stated earlier, these tools are varied within one device to contain coarse, medium, and fine rings in the chamber of the device. Likewise, a device may contain rings of the same rating so that the devices can be staged. This capability is important for use in a continuous process.

Processing a starch slurry through one or more of the high frequency, rotor-stator dispersion devices renders the fibrous material especially well suited for subsequent hydrolysis of the liquefied starch. The starch particles have been thoroughly shredded, and the associated shredded starch material is readily available for hydrolytic attack. Thus, in one embodiment, the treated starch is made to undergo acid or enzymatic hydrolysis or direct microbial conversion to produce C₅ and C₆ sugars. These sugars are saccharified, then fermented and distilled into fuel ethanol.

The process reduces degradation products and allows a greater dextrose production with a more complete fermentation production of alcohol. The liquefaction takes place at higher solids levels, specifically, 38 to 42% dry solids, which lends itself to continuous fermentation at a higher pH with reduced contamination and higher yields of ethanol.

The reactor uses less enzyme catalyst than other homogenizers because the homogenizer acts on the starch particles to increase surface area of the particles. Acid or enzyme is added to gelatinize starch in the stream. The starch particles are rapidly mixed with steam to accelerate thermal gelatinizing of the starch.

The Supraton homogenizer creates a mechanical zone of high density shear and cavitations for creating a gel at reduced temperature. The combination of shear and cavitation reduces viscosity of the starch particle mixture. The lower temperature used in the homogenizer increases the half life of the enzyme. The reactor aids in particle size reduction and reduces energy required for any grinding.

The method of the present invention, used for production of ethanol from corn kernels produces savings and improved efficiency such as the following:

| | Current Parameter | Invention | Savings |
|---|---|---|---|
| Dry Matter | 30% | 40% | 25% |
| Liquefaction Temp. | 105 C. | <100 C. | 10% |
| Steam Pressure | 80-150 psi | re-use 30 psi | |
| Water Requirement | 70% | 60% | 25% |
| Viscosity | 80,000 cp | 10,000 cp | 5% |
| Enzyme Quantity | 0.2-0.3% | 0.1-1.5% | 50% |

Additionally, the yield of the present invention, measured as GAL/BU is 2.6 to 2.7. This compares to 2.4 to 2.6 for conventional processes, resulting in savings of 3 to 4%.

Liquefaction produces a starch gel and a low viscosity mixture. In one embodiment, shown at 600 in FIG. 2B, the low viscosity mixture is heated and screened. Since the steam is introduced at the suction of the homogenizer, lower pressure steam is employed, such as waste steam from the distillation and evaporation operations. The heating is distributed with a Pick heater, manufactured by Pick of West Bend, Wis.

Fiber is screened out of the low viscosity mixture as shown at 610. In one embodiment, the fiber is combined with the fiber stream 620. In another embodiment, the stream is separately fed to a fiber utilization process, such as is described in U.S. Pat. No. 6,365,732.

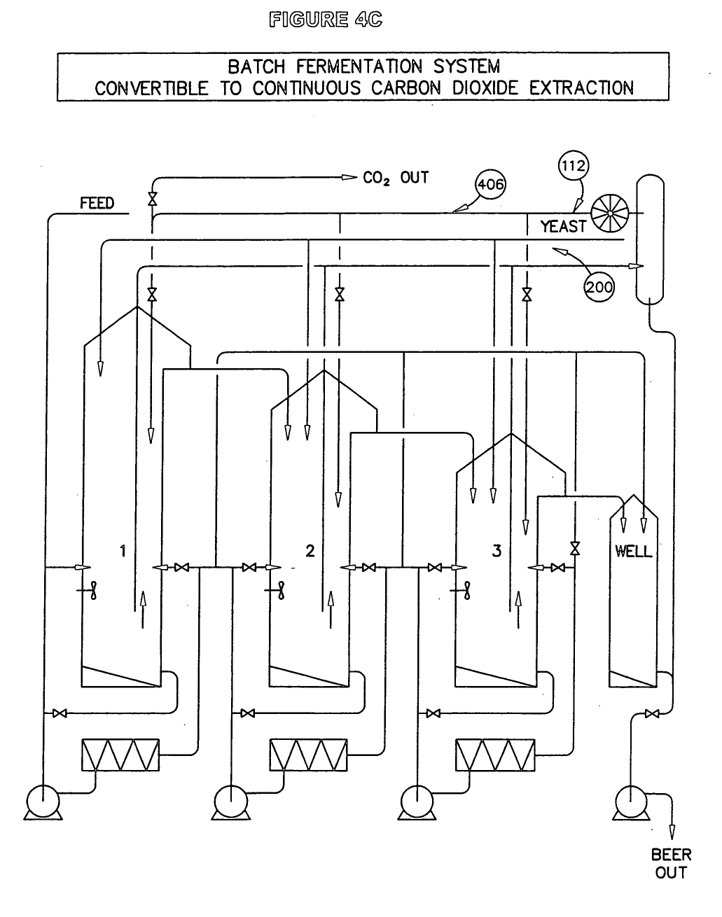

Fermentation takes place in a continuous integrated reactor, shown schematically at 700 in FIG. 4. The fermentation is continuous with an optional yeast recycle. Coarse fiber is separated to improve efficiency of exterior cooling. The method also employs gas lift mixing and transfer with recycled carbon dioxide. This method utilizes the increased dry substance of the material to control and remove objectionable bacteria. The process also includes batch operation for start-up and shut down operations.

In one embodiment, the starch gel provided by liquefaction is subjected to continuous saccharification/fermentation for production of ethanol and carbon dioxide. The ethanol feed is sufficient to produce 17-18 percent alcohol beer or higher, shown at 710 as new and better yeast strains are developed.

The fermentation uses a high dry substance material to create a high osmotic pressure in the fermentor to control and reduce foaming without chemical addition. The higher DS also naturally controls objectionable bacteria and facilitates their removal.

The removal of carbon dioxide and other volatiles, shown at 712, is also continuous. This permits the use of the gas for gas lift agitation and separations and controlled transfers. Multiple cascade fermentators are optionally operated at higher levels with multiple stages.

An extraction liquid in the form of a requisite amount of conditioned water, equaling approximately 75% of the volume of beer-containing liquid present subsequent to extraction, is made available in a recirculation tank. The extraction liquid is circulated through centrifuge 407, subsequent to which the yeast is mixed in at the intake 406 into centrifuge 407. The extraction liquid and the yeast are then immediately separated in the centrifuge, so that they are in contact briefly. The residual alcohol in the yeast is then steam stripped out and recovered. The yeast is processed into a final end product.

The cooler 412 downstream of centrifuge 407 compensates for any heating of the extraction liquid due to the centrifuging process. The brief contact time and the low temperature of the extraction liquid prevent undesired transition of yeast-metabolism products from the extraction liquid. The extraction liquid is conveyed through the centrifuge until a plate count of approximately 3 to 15% is attained.

In one embodiment, upon termination of the extraction process the extraction liquid is conveyed to heavy-duty clarifying centrifuge 402. Centrifuges of this type operate at centrifugal accelerations of up to 15000 g and accordingly remove even the insoluble tanning-agent-and-protein complexes still in the beer and responsible for residual clouding. Clarities ranging from 0.5 to 1.5 EBC can be attained with these devices, if desired.

The yeast extracted by centrifuge 407 contain 16% to 19% dry substance material. The yeast is adjusted with water to a dry-substance content of 13% to make it flow better and is preserved by adding propionic acid. The accordingly treated yeast can be sold for fodder or recycled back to the inlet to the system.

The extraction is then subjected to distillation using conventional operations. Distillation produces ethanol and bottoms. Ethanol separated in distillation is proofed for use as fuel ethanol. Bottoms are further refined to produce animal feed enriched in gluten, fiber, and proteins. Material in the still bottoms contains a high protein concentration. This material is, in some embodiments, centrifuged to produce a high protein feed that is fed to non-ruminants without use of an evaporator. The centrifuged water is used for recycle or concentrated in an evaporator to raise the protein in the fiber portion for ruminant feeds with protein/fat of 21-26 percent, as needed.

Each of the operations in the process of the present invention uses feed forward control and, optionally, feedback control, in order to remove contaminants with little or no chemical usage. The fermentation operation recycles ethanol in order to concentrate alcohol concentration. Temperature control is employed in order to improve saccharification rate and enzyme usage without sacrificing fermentation rates.

The method of the present invention produced, in addition to ethanol, germ and products derived from germ, sugar products for fermentation media, fiber and products derived from fiber. The derivative products include pectin, cellulose, lignin, arabinose, xylose, galactose, galacturonic acid and oil. The method of the present invention produces these products with a water balance that is, for some embodiments, zero discharge. Fresh water used in the operation is obtainable from water recovered in the distillation operation. Water streams are recycled to increase solids to pre-selected concentrations and are then screened to separate the solids. Valuable products are extracted from the solids. The de-concentrated water is recycled to support soaking, liquefaction or fermentation. The method of the present invention significantly reduces make-up water requirements of the fractionation process.

In one embodiment, the method of the present invention is performed in a single system. The system includes devices for soaking, germ separation, fiber separation, starch liquefaction, fermentation, protein concentration, yeast management and distillation. The devices include the devices that have been described herein.

It is to be understood that the above description is intended to be illustrative, and not restrictive. Many other embodiments will be apparent to those of skill in the art upon reviewing the above description. The scope of embodiments of the invention should, therefore, be determined with reference to the appended claims, along with the full scope of equivalents to which such claims are entitled.

1. A method for producing ethanol from corn, comprising:
Providing corn kernels comprising germ, protein, gluten, starch, and fiber;
Soaking the corn kernels in tepid water, free of sulfurous acid, containing recycled enzyme from downstream processes, in a steeping reactor for 16-20 hours to make 40 to 50% moisture content corn kernels;
Milling the steeped corn kernels to separate the germ and to form a starch-gluten-endosperm-soft starch-fiber particle;
Extracting the germ in a cyclone reactor;
Screening starch for fermentation media;
Liquefying the starch to a high dry substance;
Washing the fiber for extraction of cellulose products;
Fermenting the starch gel to form ethanol and gluten; and
Distilling the ethanol to make beverage, industrial or fuel grade ethanol.

2. The method of claim 1, wherein water used in two or more of soaking, milling, extracting the germ, homogenizing the starch-gluten-fiber, fermenting and distilling is recycled.

3. The method of claim 2 wherein no process water is discharged.

4. The method of claim 1 wherein the water used in soaking has a pH of 4.5 to 6.5.

5. The method of claim 1 wherein the maximum temperature of the starch is 200 degrees Fahrenheit.

6. A system for separating soft starch from the endosperm of grain, comprising:
a steeping reactor effective for loosening a germ component from grain, in a plug flow, without use of sulfurous acid;
A mill effective for separating the germ from the grain without fracturing the germ; and
A high speed homogenizer for separating protein from the grain and for forming a starch gel at a dry substance higher than possible with other liquefiers.

7. The system of claim 6, further comprising a cyclone reactor for extracting the germ.

8. The system of claim 6, further comprising a fermentor for fermenting the starch and forming ethanol.

9. The system of claim 8, further comprising a distillation device for extracting the ethanol.

10. The system of claim 6, further comprising a mechanism for recycling water used by the system.

11. The system of claim 6, wherein no water is discharged.

12. A method for producing ethanol from grain, comprising:
Providing grain particles comprising two or more of a germ, protein, gluten, starch, and fiber;
Soaking the grain particles in tepid water, free of sulfurous acid, in a steeping reactor for 16-20 hours to soak with recycled enzymes;
Milling the soaked grain particles to separate the germ and soft starch to form a starch-gluten-protein from the endosperm;
Extracting the germ in a cyclone reactor;
Separating the starch to produce a quality sugar/protein fermenting media;
Liquefying the starch grain slurry in a high speed homogenizer to separate the gluten and fiber from the starch;
Washing the fiber to produce extractables and cellulose products;
Centrifuging the still bottoms in a high speed centrifuge to separate the gluten and to form a protein concentrate;
Fermenting the starch to form ethanol and carbon dioxide; and
Distilling the ethanol to make beverage, industrial or fuel grade ethanol.

13. The method of claim 10, wherein water used in two or more of steeping, milling, extracting the germ, centrifuging the starch-gluten-fiber, fermenting and distilling is recycled.

14. The method of claim 11 wherein no water is discharged.

15. A method for extracting protein, fiber and starch from a mixture of grains, comprising:
Providing a first grain and, steeping the first grain in tepid water, free from sulfur dioxide in a steeping reactor for 16 to 20 hours, provided the first grain has a germ portion, to make first grain steeped particles;
Providing a second grain to make starch gel from whole grain;
Separately milling the first steeped grain particles to separate the germ and to form a starch-gluten-fiber particles;
Milling the second grain without steeping;
Separately extracting the germ from the first grain steeped particles and the second grain steeped particles in a cyclone reactor; and
Blending the starch-gluten-fiber particles from the first grain and the second grain.

16. The method of claim 13, further comprising separating fiber from the grain particles in the mixture.

17. The method of claim 13, further comprising separating protein from the grain particles in the mixture.

18. The method of claim 13, further comprising separating starch from the grain particles in the mixture.

19. A pre-cleaning mechanism for separating grain particles, comprising:
A mechanism for separating the germ from the grain particle without fracturing the germ;
A mechanism for separating fiber from the grain particle;
A mechanism for separating quality starch and hard starch from endosperm;
A mechanism for liquefying the starch at high dry substance with low pressure steam;
A mechanism for forming ethanol from starch;
A mechanism for distilling ethanol; and
A mechanism for isolating high protein, non-ruminant feed.

20. The mechanism of claim 19, further comprising a mechanism for recycling water used in the system.
